(19) United States
(12) Patent Application Publication
(10) Pub. No.: US 2002/0013737 A1
(43) Pub. Date: Jan. 31, 2002

(54) Shopping information providing system

(76) Inventor: Shinya Arai, Tokyo (JP)

Correspondence Address: ROSENTHAL & OSHA L.L.P., Suite 4550, 700 Louisiana, Houston, TX, 77002, US

(21) Appl. No.: 09/867,072

(22) Filed: May 29, 2001

(30) Foreign Application Priority Data
May 29, 2000 (JP) P2000-158679

(51) Int. Cl. G06F 17/60

(52) U.S. Cl. 705/26

(57) ABSTRACT

A shopping information providing server includes a customer database which stores the ID of a user and family information of the user in correspondence with each other, a menu database which stores a menu item, types of material necessary for the menu, and necessary quantities in correspondence with each other, and a special sale information database which stores a providing source, an article for special sale, and its price in correspondence with each other. In accordance with a request from the user, the server provides information of an article to be purchased, including special sale information, checks the reserve articles of the user on the stock information database, and generates and provides a shopping list including the reserve article without stock.

### BACKGROUND OF THE INVENTION

1. Field of the Invention

The present invention relate to a system for providing shopping information and, more particularly, to a technique related to a system for calculating the contents and quantities of materials necessary for a selected menu on the basis of user information, comparing them with special sale information, and providing, to the user, information related to articles to be purchased, including information related specials.

2. Related Background Art

On the Internet, web sites provide various kinds of information to a user. Especially, some web sites provide the types of articles and price information thereof, thereby prompting the user to purchase them.

Presently, however, the Internet has no web site capable of providing information about purchase of materials of proper types and quantities necessary for a desired menu, including the user family information and stock information. For this reason, the user specifies the types of materials related to the desired menu from a cookbook or the like, calculates or arranges the purchase quantities on the basis of the necessary quantities and stocks on the basis of the family members, individually checks, on leaflets, the special sale information of supermarkets, and picks up necessary articles and articles for special sale, thereby obtaining information of food items to be purchased. The user himself/herself must first obtain materials necessary for the desired menu and calculate the quantity information of the materials and the required quantities of necessary articles, resulting in inconvenience. In addition, the user must see on the basis of the leaflets of each supermarket if the articles are for special sale of the supermarket and always grasp the presence/absence of stock and stock amounts in the house. Selection and purchase for daily menus have been a worry for a user who prepares daily meals for the family.

### SUMMARY OF THE INVENTION

It is an object of the present invention to provide a shopping information providing system for solving the above problems and providing appropriate shopping information to a user.

In order to achieve the above object, according to the present invention, there is provided a shopping information providing server for providing shopping information, comprising a customer database which allows authentication of a user upon receiving an input ID with a password and stores the ID of the user and family information of the user in correspondence with each other, a menu database which stores a menu item, a type of a material necessary for the menu, and a necessary quantity of the material in correspondence with each other, first storage means for authenticating the user using the customer database in accordance with an input from the user and storing the family member information of the authenticated user, second storage means for receiving menu selection information from the user and storing, on the basis of the selected menu, a type of article necessary for the menu and a necessary quantity of the article, calculation means for calculating a total necessary quantity necessary for the selected menu for all family members on the basis of the family member information stored in the first storage means and the type and necessary quantity of the article stored in the second storage means, information providing means for storing the article and necessary quantity calculated by the calculation means, and special sale information database which stores a providing source, and an article for special sale and a price thereof in correspondence with the providing source, wherein when the article stored in the information providing means is compared with articles stored in the special sale information database, and a matching article is detected, the matching article is marked with a symbol, and special sale information in the special sale information database, which is special sale information selected by the authenticated user, is stored in the information providing means in correspondence with the providing source, and the information stored in the information providing means is provided to the authenticated user in accordance with a request from the authenticated user.

According to the present invention, there is also provided a shopping information providing client/server system connected by interactive communication means, comprising a customer database which stores an ID of a user and family information of the user in correspondence with each other, a menu database which stores a menu item, a type of a material necessary for the menu, and a necessary quantity of the material in correspondence with each other, first storage means for authenticating the user using the customer database in accordance with an input from the user and storing the family member information of the authenticated user, second storage means for receiving menu selection information from the user and storing, on the basis of the selected menu, a type of article necessary for the menu and a necessary quantity of the article, calculation means for calculating a total necessary quantity necessary for the selected menu for all family members on the basis of the family member information stored in the first storage means and the type and necessary quantity of the article stored in the second storage means, information providing means for storing the article and necessary quantity calculated by the calculation means, and special sale information database which stores a providing source, and an article for special sale and a price thereof in correspondence with the providing source, wherein when the article stored in the information providing means is compared with articles stored in the special sale information database, and a matching article is detected, the matching article is marked with a symbol, and special sale information in the special sale information database, which is special sale information selected by the authenticated user, is stored in the information providing means in correspondence with the providing source, and the information stored in the information providing means is provided to the client apparatus in accordance with a request from the authenticated user.

According to the present invention, there is also provided a shopping information providing method comprising the steps of authenticating a user using a customer database which allows authentication of a user upon receiving an input ID with a password and stores the ID of the user and family information of the user in correspondence with each other, and selecting and storing the family information of the authenticated user, storing a type and necessary quantity of a material necessary for a menu selected by the user using a menu database which stores a menu item, a type of a material necessary for the menu, and a necessary quantity of the material in correspondence with each other, calculating and storing a total necessary quantity necessary for the selected menu for all family members on the basis of the stored family member information and the stored type and necessary quantity of the material, storing special sale information including an article for special sale and a price from a providing source in correspondence with the providing source, and comparing the material obtained in the calculation and storage step with articles stored in a special sale information database, and when a matching article is detected, providing, to the authenticated user, special sale information of the matching article for special sale together with the information stored in the calculation and storage step.

As described above, in the shopping information providing server and client, the system thereof, and the shopping information providing method according to the present invention, total necessary quantities related to a selected menu are automatically calculated on the basis of the family information. In addition, comparison with special sale information is done to notify the user whether articles for special sale include the materials to be used for the menu, thereby prompting and supporting the user to decide the menu and select an article to be purchased.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view showing the schematic view of an embodiment of the present invention.

FIGS. 2A to 2C are views showing the data structures of a customer information database 302, menu database 303, article price database 304, and stock information database 305 in the shopping information providing server according to the embodiment of the present invention.

FIG. 3 is a flow chart showing a processing method in the embodiment of the present invention.

### DETAILED DESCRIPTION OF THE PREFERRED EMBODIMENTS

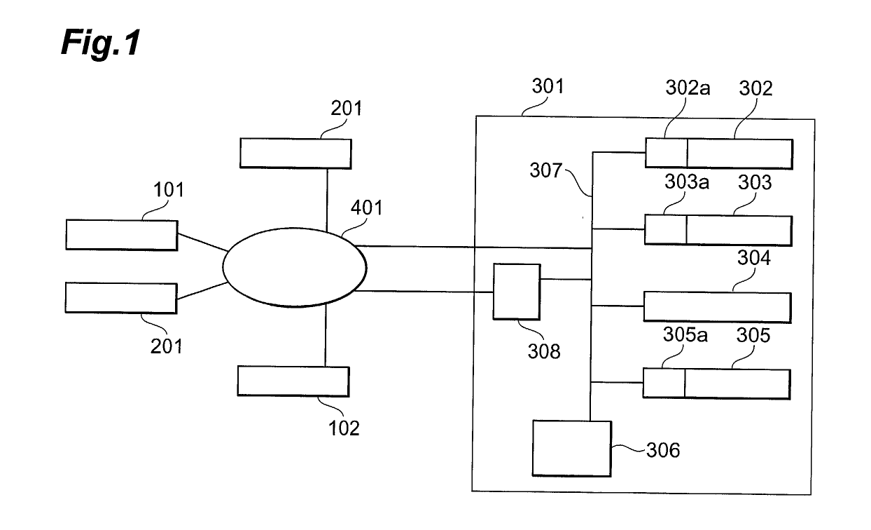

A shopping information providing system according to an embodiment of the present invention will be described below with reference to the accompanying drawings. FIG. 1 is a block diagram showing the arrangement of an embodiment of the present invention.

As shown in FIG. 1, the shopping information providing system according to the present invention comprises client apparatuses 101 and 102, providing sources 201 and 202 such as supermarkets for providing special sale information, and a shopping information providing server 301. These apparatuses are connected through the Internet 401 to exchange information.

The shopping information providing server 301 has a customer information database 302 which stores a user ID, and password and family member information in relation to the user ID, a menu database 303 which stores menu items, and the types and quantities of materials necessary for a menu in relation to the menu item, a special sale information database 304 which stores specials, their prices, and providing source information input from the providing sources 201 and 202 in correspondence with the specials or providing source information, a stock information database 305 which stores the stock information of the user in relation to the user ID, and a calculation unit 306 for calculating information extracted from these databases. These units are connected through a data bus 307 to communicate with each other. A providing means 308 for temporarily storing information to be provided to the user is connected to the data bus 307.

The customer information database 302 and stock information database 305 have storage means 302a and 305a for temporarily storing information related to the input user ID in accordance with an external request to the server, respectively. The menu database 303 is connected to a storage means 303a for temporarily storing the types and necessary quantities of materials necessary for a selected menu on the basis of input menu selection information.

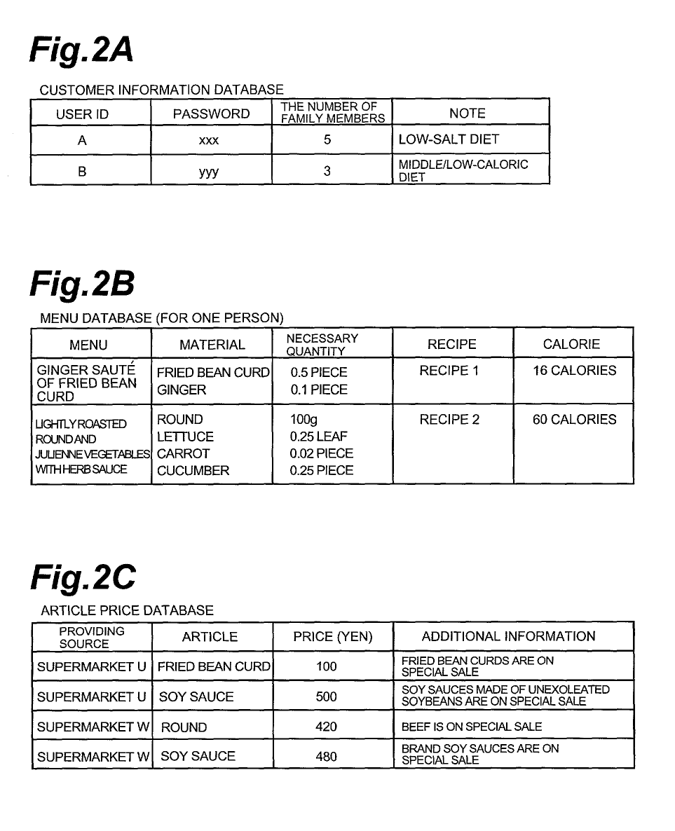

FIGS. 2A to 2C show the pieces of information stored in the customer information database 302, menu database 303, special sale information database 304, and stock information database 305.

As shown in FIG. 2A, the customer information database 302 stores user IDs, passwords, and the total numbers of family members, and features, e.g., information of a low-salt diet or middle/low-caloric diet, using the user IDs as keys.

As shown in FIG. 2B, the menu database 303 stores menu names, names of materials necessary for one person, the necessary quantity of each material, the recipes for the menus, and the caloric data of the menus, using the menu names as keys. This menu database 303 can be occasionally updated by an external operation and can be updated to have contents corresponding to the season.

As shown in FIG. 2C, the special sale information database 304 stores the providing sources, articles for special sale, and prices of articles for special sale. In addition, notes, e.g., introduction of foods in season or advertisement expressions are stored such that they can be searched using the providing source and article for special sale as keys. These contents are accessed from the providing sources 201 and 202 such as supermarkets and updated to the latest information.

The stock information database 305 stores the presence/absence of reserve articles, e.g., seasonings such as soy sauce, salt, and soybean paste in the user's home, using the user ID as a key.

Using the customer information database 302, menu database 303, special sale information database 304, and stock information database 305, a user who has accessed the shopping information providing server through the Internet is prompted to input information using his/her ID. Additionally, on the basis of the input data, the list of articles necessary for a selected menu, the quantities of articles to be purchased, the recipe of the selected menu, and special sale information and, more particularly, whether the materials (articles) necessary for the selected menu are for special sale are specified. Furthermore, the necessity of purchase of reserve articles that the user should stock is provided to the user.

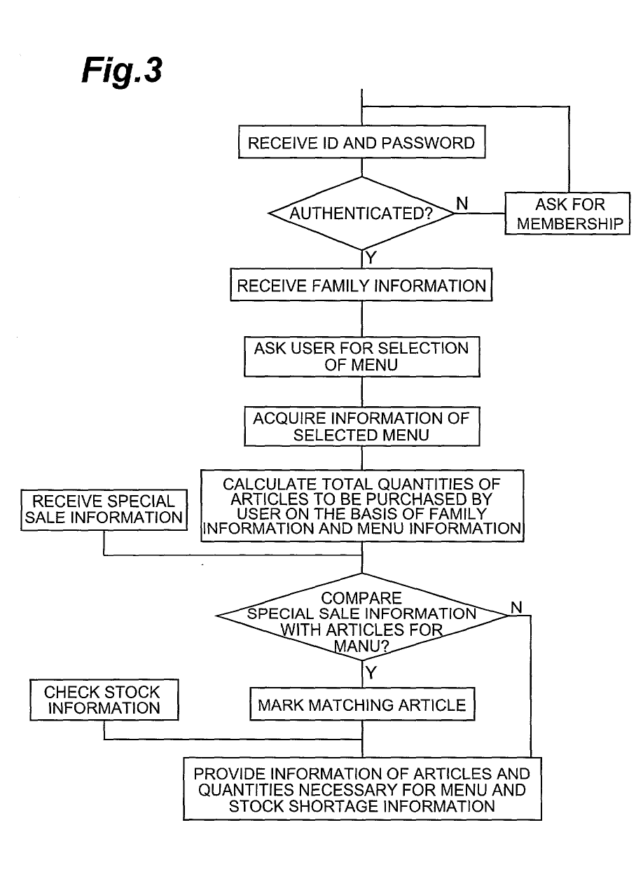

FIG. 3 is a flow chart showing the operation of the shopping information providing system and, more particularly, the shopping information providing server.

As shown in FIG. 3, first, when a user A accesses the shopping information providing server through the Internet using the client apparatus 101 or 102, the customer information database 302 is accessed to check whether the user has already been registered. If the user has already been registered, the family member information stored in the customer information database 302, e.g., the total number of family members and note, i.e., whether a diet for hypertension is preferable, is stored in the temporary storage means 302a. If the user is unregistered, the user is prompted to register himself/herself. If the user agrees, he/she is prompted to input predetermined items, e.g., the family member information as shown in FIG. 2A. When the family member information is input, and confirmation of user's intention for registration is input, a user ID and password are issued. When data are input using the user ID and password, it is determined that the user is a registered member, and the following processing is executed.

Using family information specified by the ID-A of a user 101a authenticated as a registered member, information stored in the special sale information database 304, and information stored in the menu database 303, the list of selectable menus is presented to the user to prompt him/her to select a menu. Being prompted to select a menu, the user 101a selects a menu, e.g., “lightly roasted round and julienne vegetables with herb sauce”. On the basis of the selection instruction from the user 101a, the shopping information providing server 301 accesses the menu database 303 and temporarily stores, in the second storage means 303a, articles “round, lettuce, carrot, and cucumber” necessary for “lightly roasted round and julienne vegetables with herb sauce” and the quantities of articles “100 g, 0.25 leaf, 0.02 piece, and 0.25 piece ”. The number of persons “five” for the menu is extracted from the family information stored in the first storage means 302a in advance. The necessary quantities of articles stored in the second storage means 303a, “100 g, 0.25 leaf, 0.02 piece, and 0.25 piece”, are multiplied by the number of persons “five” by the calculation unit 306 (round: 500 g, lettuce: 1.25 leafs, carrot: 0.1 piece, and cucumber: 1.25 pieces). The necessary articles and multiplication results of the articles (round: 500 g, lettuce: 1.25 leafs, carrot: 0.1 piece, and cucumber: 1.25 pieces”) are stored in the information providing means 308. Next, the articles “round and the like” necessary for the menu, which are stored in the information providing means, are compared to the special sale information “round, fried bean curd, and soy sauce” stored in the special sale information database. It is checked whether the special sale information includes an article (round) for special sale corresponding to the article “round” stored in the providing means 308. If a corresponding article for special sale is included, a symbol representing an article for special sale is attached to the stored article “round” to attract attention of the user 101a in providing the information.

In the above processing, stock information of the authenticated user 101a (ID-A) is checked on the stock information database 305, and a reserve article without stock, salt in this embodiment, is stored in the providing means. The stock information can be automatically checked, i.e., the presence of reserve articles in stock can be automatically checked or visually confirmed and manually input by the user. When it is determined that a reserve article has no stock, the reserve article is compared with the articles for special sale in the special sale information database 304. A matching article is marked and stored in the providing means 308. This article is particularly marked as an article to be purchased and provided as information.

The user 101a is notified of special sale information stored in the special sale information database 304, “fried bean curd, ginger, round, lettuce, carrot, and cucumber” in this embodiment, and prompted to select information. The special sale information selected by the user in accordance with this notification is also stored in the providing means 308.

In accordance with the request from the authenticated user 101a, the pieces of information stored in the providing means 308, i.e., the menu name “lightly roasted round and julienne vegetables with herb sauce”, the articles necessary for the menu, “round, lettuce, carrot, and cucumber”, and their necessary quantities “500 g, 1.25 leafs, 0.1 piece, and 1.25 pieces”, the selected special sale information (including the providing source, price, and article name), and the information of reserve article “salt” to be purchased are provided to the authenticated user 101a. In providing the information, since “round” can be marked and presented as an article necessary for the menu and also as an article for special sale, the user can purchase “round” as an article for special sale. This information can also be effectively used to select the menu.

In the shopping information providing server and client, the system thereof, and the shopping information providing method according to the present invention, total necessary quantities related to a selected menu are automatically calculated on the basis of family information. In addition, comparison with stock information is done to provide, to the user, an article to be purchased, thereby increasing the convenience for the user.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A shopping information providing server for providing shopping information, comprising:
a customer database which allows authentication of a user upon receiving an input ID with a password and stores the ID of the user and family information of the user in correspondence with each other;
a menu database which stores a menu item, a type of a material necessary for the menu, and a necessary quantity of the material in correspondence with each other;
first storage means for authenticating the user using said customer database in accordance with an input from the user and storing the family member information of the authenticated user;
second storage means for receiving menu selection information from the user and storing, on the basis of the selected menu, a type of article necessary for the menu and a necessary quantity of the article;
calculation means for calculating a total necessary quantity necessary for the selected menu for all family members on the basis of the family member information stored in said first storage means and the type and necessary quantity of the article stored in said second storage means;
information providing means for storing the article and necessary quantity calculated by said calculation means; and
special sale information database which stores a providing source, and an article for special sale and a price thereof in correspondence with the providing source,
wherein when the article stored in said information providing means is compared with articles stored in said special sale information database, and a matching article is detected, the matching article is marked with a symbol, and special sale information in said special sale information database, which is special sale information selected by the authenticated user, is stored in said information providing means in correspondence with the providing source, and
the information stored in said information providing means is provided to the authenticated user in accordance with a request from the authenticated user.

2. A shopping information providing client/server system having a client apparatus and a server apparatus for providing shopping information, comprising:
a customer database which stores an ID of a user and family information of the user in correspondence with each other;
a menu database which stores a menu item, a type of a material necessary for the menu, and a necessary quantity of the material in correspondence with each other;
first storage means for authenticating the user using said customer database in accordance with an input from the user and storing the family member information of the authenticated user;
second storage means for receiving menu selection information from the user and storing, on the basis of the selected menu, a type of article necessary for the menu and a necessary quantity of the article;
calculation means for calculating a total necessary quantity necessary for the selected menu for all family members on the basis of the family member information stored in said first storage means and the type and necessary quantity of the article stored in said second storage means;
information providing means for storing the article and necessary quantity calculated by said calculation means; and
special sale information database which stores a providing source, and an article for special sale and a price thereof in correspondence with the providing source,
wherein when the article stored in said information providing means is compared with articles stored in said special sale information database, and a matching article is detected, the matching article is marked with a symbol, and special sale information in said special sale information database, which is special sale information selected by the authenticated user, is stored in said information providing means in correspondence with the providing source, and
the information stored in said information providing means is provided to the client apparatus in accordance with a request from the authenticated user.

3. A shopping information providing method comprising the steps of:
authenticating a user using a customer database which allows authentication of a user upon receiving an input ID with a password and stores the ID of the user and family information of the user in correspondence with each other, and selecting and storing the family information of the authenticated user;
storing a type and necessary quantity of a material necessary for a menu selected by the user using a menu database which stores a menu item, a type of a material necessary for the menu, and a necessary quantity of the material in correspondence with each other;
calculating a total necessary quantity necessary for the selected menu for all family members on the basis of the stored family member information and the stored type and necessary quantity of the material;
storing special sale information including an article for special sale and a price thereof from a providing source in correspondence with the providing source; and
comparing the material obtained in the calculation step with articles stored in a special sale information database, and when a matching article is detected, providing, to the authenticated user, special sale information of the matching article for special sale together with the information calculated in the calculation step.

4. A shopping information providing server according to claim 1, wherein
said server further comprises a stock information database which stores stock information corresponding to the user ID, and
stock shortage information in the stock information database is provided to the authenticated user.

5. A shopping information providing client/server system according to claim 2, wherein
said server further comprises a stock information database which stores stock information corresponding to the user ID, and
stock shortage information in the stock information database is provided to the authenticated user.
